(19) United States
(12) Patent Application Publication
(10) Pub. No.: US 2005/0141973 A1
(43) Pub. Date: Jun. 30, 2005

(54) Production line

(76) Inventors: Burkhart Grob, Bad Worishofen (DE); Anton Kienle, Salgen (DE); Knut Martens, Mindelheim (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/960,007

(22) Filed: Oct. 8, 2004

(30) Foreign Application Priority Data
Oct. 10, 2003 (DE) 103 47 913.9

(51) Int. Cl. B23Q 41/08

(52) U.S. Cl. 409/137

(57) ABSTRACT

The invention refers to a production line comprising at least two machine tools set up on the floor where at least between the two machine tools a device is provided for the conducting of rinsing and cooling fluids. The device is designed here essentially closed and sealed. It is equipped in the region of the machine tool with connections. The device is arranged on, respectively above, the floor or the level of the set-up surface of the machine tools.

The invention refers to a production line comprising at least two machine tools standing on the floor where at least between the two machine tools a device for conducting rinsing or cooling fluid is provided.

### BACKGROUND OF THE INVENTION

In production lines, for example in transfer lines or in interlinked machining centers, it is known to provide central supply and removal systems. In a central apparatus, for example, the rinsing and cooling fluid which is needed in a cutting machining process is recycled. Here the rinsing or cooling liquid serves, on the one hand, for cooling the work piece and, on the other hand, for removing worked-off chips.

This rinsing and cooling fluid has then to be disposed of and let off from the machining tool accordingly. Conveniently here the respective machine tools have advantageous designs so that chips and other impurities can reliably be removed from the machining tool.

For that purpose devices for conducting rinsing or cooling fluids are provided.

In the state of the art it is known in this connection to arrange open rinsing channels between the machining tools.

The use of open rinsing channels allows the passing into of rinsing and cooling fluid at any place. However, it is a disadvantage in this embodiment that the rinsing channel can never be filled completely as there is the risk of the rinsing and cooling fluid to spill over as the surface of the rinsing and cooling fluid is always troubled because of the subsequently passed into rinsing and cooling fluid. This means that in these arrangements the possible flow of rinsing and cooling fluid is not used completely. The loss of fluid in the open guided channel is not small, either, as in the work halls where the production lines are set up considerable temperature can prevail and the evaporation loss may be considerable.

Furthermore it is known to build in devices for the conduction of rinsing and cooling fluids into the hall floor in specially provided grooves or channels, which may be covered, if necessary. Here the known channels are simply installed in a groove in the floor and covered by suitable floor plates. The loss of rinsing and cooling fluid because of evaporation is here already reduced, however, arrangements of this kind have several other disadvantages.

The production lines have a considerable weight and the foundation of the hall has to be built accordingly stable. However, the groove weakens the foundation and measurements have to be taken in order to compensate this, leading to considerable higher expenses in the construction of the hall where the production line has to be set up. Furthermore the arrangement of the channel installed in the floor restricts the use of the hall. If, for example, moving is planned of a corresponding production line, it can only be set up in the range of this channel which will lead unavoidably to disadvantages, as this infrastructure cannot be switched economically to the new conditions.

Another disadvantage of the arrangements of the device in a channel installed in the floor is the case of leakage. In this case the rinsing and cooling fluid passes, possibly without being noticed, into the foundation of the floor plate or into the soil and may lead to corresponding damages. In order to avoid this the channels provided in the floor are comparatively expensive and therefore also costly.

Also chip-transporting systems are known which can at least take a part of the rinsing or cooling fluid. Systems of this kind, however, are characterised by the fact that they are not built closed. This makes it possible that parts of the cooling or rinsing fluid evaporate, respectively cooling or rinsing fluid may get to the floor of the production hall by splashing during passing into the collecting channel. The known systems here are designed in such a way that a collecting channel is arranged at a level which makes an additional arrangement, respectively fastening possibility, necessary, making the matter more expensive altogether.

There are other known systems which are also characterised by a partially open channel and supply for the chips and, if necessary, the cooling or rinsing fluid. Here a graduated embodiment is provided in such a way that the connection of channel parts for the individual machine tools is designed very expensively and that, by means of that, in particular the risk of obstruction, respectively congestions, occurs in the bent region. The known device in the state of the art is additionally intended to remove chips. Therefore it is not, or only with restrictions and with considerable technical and machine effort possible to let off cooling or rinsing fluid in such a known device.

### BRIEF SUMMARY OF THE INVENTION

It is an object of the invention to provide a production line as described in the beginning the device of which is as flexible and efficient as possible for letting off rinsing, respectively cooling, fluid.

This problem is solved by a production line as described in the beginning where the device is essentially designed closed and sealed, which has connections in the region of the machine tool and the device is arranged on the floor or above the level of the put-up surface.

The closed, sealed embodiment of the device achieves that the filling ratio of the device can be increased considerably compared with the open channels as there is no risk of spilling over on the upper edge of the channel which would be open in the other embodiment.

The risk of spilling over is stopped by the embodiment according to the invention. The available cross-section for the duct device may be used efficiently and completely for conducting rinsing and cooling fluid without the risk to soil the floor of the hall by leaking rinsing or cooling fluid or to loose rinsing or cooling fluid. At the same time also by means of the closed embodiment the evaporation loss is reduced considerably. As the duct device is not arranged in the floor but on or above the floor, the production line designed according to the invention is also very flexible as it can be dismounted without any problems and be set up at another place, and the arrangement of a suitable infrastructure in the floor of the hall is not decisive for the operation of the production line. No additional expenses have to be provided with regard to the floor of the hall if the production line has to be reconverted as the production line comprises already the disposal ducts for rinsing and cooling fluid of the line, respectively of the machine tools provided in the line.

At the same time the device arranged above the floor and, preferably, on the machine, is easy to assemble and maintain, as it is accessible from several sides without any problem. Leakages of the device which may occur can be recognised here immediately and can be removed accordingly.

An additional effort for the installation as it is, for example, necessary for the use of known chip conveying systems in order to enable them to transport rinsing or cooling fluid at all, is completely unnecessary. Thus, for example, pumps, additional conveying ducts for the fluid and filter apparatus, respectively sieving apparatus, which guarantee a correct function of pumping, respectively removing the fluid are not necessary according to the invention. The use of chip conveying devices, respectively their use as rinsing or cooling draining system seems not suitable for the solution of this problem because of the enormous effort. Vice versa, however, it is possible to equip the device according to the invention with an additional chip conveying system.

In a preferred embodiment of the invention it is provided that the device is designed modular. The modular design has considerable advantages for mounting, maintaining, respectively dismounting of the device. The arrangement is chosen here in such a way that the modules can be exchanged independently, respectively the modules are assigned to the respective machine tool and therefore also the exchange of a machine tool in the production line inclusively the conduction device is possible without any problems.

Preferably at least two different types of modules are provided. First of all a linking module which is substantially closed and profile-like is provided. This linking module, which is preferably tube-like, can be used, for example, for a closed connection of the machine tools. Besides connection modules are provided which have at least one connection. At the connection the sewage duct for the rinsing or cooling fluid of the machine tool is connected. Preferably this is, for example, a chip collecting funnel or a rinsing channel. Alternatively also several connections are provided at a connection module, if, for example, several sewage ducts lead away from one machine tool, or a connection module serves for two or more machine tools set up in opposition to each other.

According to a development of the invention it is provided that the device is designed as a construction on the floor, in particular that it can be set up below the machine tool. This possibility of setting up is in particular important with regard to the efficient design of a production line and in particular for enlarging and/or moving of one. Solutions known according to the state of the art are either arranged in the floor as so-called under-floor construction or on special frames beside or above the production line. This needs a considerable higher effort for the production of such a device and such an embodiment is a disadvantage when the production line has to be enlarged or moved. Also for moving into a new production hall, for example, the effort for building the sewage channel, as they are necessary in the solutions according to the state of the art is extremely high. The empty production hall has also to be renovated, if necessary, in view of the construction which also causes considerable expenses.

Another aspect of the invention is the fact that the device is designed tube-like. In particular the embodiment with a circular, tube-like device has the advantage here that tube-like devices of this kind can be linked very easily. For that purpose simple tube couplings are used. It is, for example, also possible to provide in-line quick couplings designed very tightly by means of which single parts of the device can be assembled. Even the maintaining of such an embodiment is essentially simpler. The main advantage of a tube-like embodiment, however, is the production. Costs can be considerably reduced there, by manufacturing tube-like devices of this kind in the shape of device modules or segments.

It is an advantage if, according to a development of the production line according to the invention, a first group of several machine tools is connected with a first, in particular tube-like, device. The device is provided here as a so-called one-tube embodiment. A one-tube embodiment has to be understood here in such a way that a central collecting, respectively sewage, channel of the device is designed as a single tube. In this device of a one-tube embodiment machine tools, respectively their sewage ducts, can be integrated. Depending on the capacity of the device the diameter of the device has to be dimensioned.

If a one-tube embodiment is not sufficient anymore it is provided, according to the invention, that two or more groups of machine tools each are connected to their own device, preferably separated from the other devices, and these devices are arranged at least in segments parallel, in particular running bunched. This embodiment may also be called a one-plus-x-tube embodiment. At the beginning of the device here a one-tube embodiment may be provided which enlarges towards the end, respectively towards the center of the production line, to become a two- or more-tube embodiment. This depends on the respective machining tasks and the occurring amount of cooling, respectively, rinsing fluid. Of course, according to a modification of the invention, an enlargement module is provided for connecting two or more devices. By means of such an enlargement module there will be then the possibility to use at first smaller diameters and, after the intended rate of flow has been reached, to connect a larger diameter to the enlargement module. This enlargement module is here not restricted to the connection of two devices of this kind but can be enlarged to a multitude of integrations of devices.

It has proved to be an advantage if the enlargement module is designed bent, in particular bent segment-like. By means of that this enlargement module can be arranged at certain spots of the production line where a by-pass of the cooling or rinsing fluid is required. For example, this detour may also serve for connecting two or more devices of manufacturing or production lines arranged parallel to each other.

A development of the invention suggests that a final module is provided which receives all devices of the production line. In this final module, for example, then a removal device, respectively pumping device, into a central collecting container, respectively a recycling installation, may be provided for the cooling or rinsing fluid.

In the region of the machine tool the devices, respectively the connections of the devices, are connected by supplies to the device itself. This creates a tight connection without any problems between the machine tool and the device itself.

It is an advantage here if a collecting module is provided for connecting the device with the machine tool.

This collecting module is, according to a development of the invention, designed as basic trough into which the cooling or rinsing fluid can be passed. The design as basic trough is preferred as by means of that spilling or loss and also unnecessary evaporation of cooling or rinsing fluid can be avoided.

A preferred development of the invention provides that the basic trough is in two pieces, in particular as an embodiment with a rinsing trough in a basic trough. This achieves additional security with regard to spilling cooling or rinsing fluid. In particular cooling or rinsing fluid spilling over from the rinsing trough can then still be collected in the basic trough. According to the requirements to production technique and, in particular, the requirements with regard to environment protection it has to be avoided reliably that cooling or rinsing fluid contaminates the floor of the production hall. Therefore this double safety in the shape of the design as basic trough with an integrated rinsing trough is a particular advantage.

A development of the invention provides that the rinsing trough is designed, at least in the entry region for the cooling or rinsing fluid, respectively on the side facing the machine tool, shaped like a W. This W-shape achieves a convenient sewage of the rinsing or cooling fluid. Furthermore this results in an embodiment which is essentially sealed downwards so that cooling or rinsing fluid cannot be splashed.

The rinsing trough and the basic trough are designed inclined in the direction of the device. It is a particular advantage here if the inclination is chosen with a very small gradient. Already an extremely small gradient of the rinsing trough, respectively the basic trough, is sufficient to guarantee a regular and secure drain of the cooling or rinsing fluid.

The W-shaped entry region of the rinsing trough can also be formed, according to an embodiment of the invention, by two V-channels. The advantage is the same as described above.

According to the invention it has been found to be an advantage if the supply is provided as bent transition piece for connection with the device. This bending in particular in the direction of the drain guarantees a continuous and easy drain of the cooling or rinsing fluid, as the rinsing or cooling fluid passed into is by-passed in the sewage direction in the device.

Another aspect of the invention is given by the fact that the basic trough is provided as housing for the rinsing trough. By means of this design a double embodiment is secured and, simultaneously, it is avoided that an additional housing has to be provided for the basic trough. This lowers also the costs of production.

An advantageous development of the production line according to the invention provides that the basic trough is additionally at least partly designed as leakage trough in such a way that cooling or rinsing fluid spilling over from the rinsing trough is collected. This makes sure that the spilled cooling or rinsing liquid cannot overflow and contaminates the floor. The safety is increased further by such an arrangement.

According to the invention, in another aspect of the invention, a leakage duct is provided through which the leakage of the leakage trough can be let off. This makes sure that even the leakage can be disposed off securely and without any problems, in particular without causing soiling and contamination. Preferably the leakage duct is arranged here at a level below the supply, respectively the transition piece for connecting the collecting module and the device.

Furthermore it has been found to be an advantage to arrange a central leakage collect duct parallel to the device. Thus the leakage let-off is even then secured when the level of the cooling or rinsing fluid in the device itself is too high so that no leakage could drain. The central leakage collect duct can here be passed into an enlargement module or in the final module.

The invention is also characterised by the fact that at the basic trough a connection to the casing of the production machine is provided for letting off of fluid dripping from the casing.

In a preferred embodiment of the invention it is provided that the device has the cross-section of a one-piece component. According to the invention the aim is to be able to apply an economic production process for these modules. It is, for example, possible to design the modules of the device tube-like and to produce them, for example, in a rolling process.

Alternatively it is provided that the device is designed as weldment, the construction having at least a bottom part and a top part which are connected by welding. For example, the bottom and the top part consist of plate material which is suitably buckled, turned over or folded in order to reach a suitable contour of the device altogether. Top and lower part can be connected here by one, two or more weld seams which in particular, preferably, extend longitudinally. The arrangement is not determined that necessarily bottom part and top part have to be provided in a separate component. It is actually possible to design bottom part and top part each in a folding process accordingly and then to connect the already one-sided connected bottom part and top part by welding them to each other. The advantage of a weldment is in particular that a closed and sealed connection is realised through it.

Alternatively it is furthermore provided that the device comprises a bottom part and a top part which can be put on the bottom part and which can be connected tight with it. For that purpose suitable connecting means, for example screws or the like, may be provided. Such an embodiment allows in particular also a reverse of the use of a module by keeping the bottom part but exchanging the top part of a linking module for the top part of a connection module. In any case, however, here a high efficiency, that means a good use of the space available for the device in the production line, is reached, as the filling level in the device according to the invention is higher as in the open channels where, possibly, there is the risk of spilling over of the cooling or rinsing fluid. Eventually the complete region where the rinsing and cooling fluid circulate is, if possible, encapsulated.

According to the invention it is provided that the device has a tube-like cross-section, that means, if necessary, circular, oval, box-like, that is essentially rectangular, or channel-like. In particular a channel-like design which is closed in the upper region by a top part is convenient; it can be used in the lowest spot of the channel as chip conveyor in order to convey the chips deposited here. The design of the cross-section refers here, in particular, to the conditions of the production line, respectively the machine tool, in order to optimise the desired flow of rinsing or cooling fluid. Possibly this may result in other designs of the cross-section where for example reniform modifications or the like may also be possible as cross-section.

The arrangement of the design of the modules is, according to the invention, cleverly chosen so that the modules, when they are mounted to each other, have a gap, however, the modules have a seal at least at one of their longitudinal ends, and the seal closes this gap by interacting of the fastening means (which serve for connecting the modules) with the seal in the mounted condition. The result is an easy assembling, respectively dismounting, of the device of the production line according to the invention as the individual modules are slightly shorter as the available space and the seals seal the remaining gap. The result is that it becomes considerable more easy because of a flexible reaction to different requirements of the production line as the effort for removing a machine tool from the production line including the replacement of the device is carried out, according to the invention, simpler and faster. The device designed in that way also allows in a simple way the compensation of inaccuracies in longitudinal direction as this is compensated by the seal, which has to be dimensioned accordingly. The simplification of mounting and dismounting therefore corresponds with a compensation of position which can be realised easily; the effort for accuracy for the arrangement of the device therefore does not have to be so large anymore.

According to the invention a support means is provided for the device. The support means serves for supporting the device. There are several modifications for this purpose. First of all it is possible that the support means allows a support of the device at the machine tool or the machine frame. Especially in a module-like construction this is an advantage. Cleverly here, for example, the connection module is supported by the machine tool in the region of the machine tool and the connecting flanges for the connecting linking modules are arranged a bit outside the machine tool, making the mounting and dismounting of the complete machine tool, for example during the switch of the production line, easily possible. The respective module is attached here, by means of its support, to the machine tool and does not have to be dismounted separately. It is possible here that the device is suspended from or stands on or is supported by the machine tool, respectively the machine frame.

Alternatively it is, of course, possible to use set-up feet set upon the floor as support means. Such a support means can, in particular, be convenient in a surrounding where suspending from the machine is not possible.

It is an advantage that a support means is used the length, respectively the height, of which can be adjusted. On the one hand a highly accurate positioning of the device in the production line can be set. Furthermore it has to be considered that there is a small inclination of the device for simple draining of the fluid. This can be achieved without any problems by the possibility of adjustment.

According to the invention it is provided that the machining station or machine tool (as they are called equivalently in the following) are designed as cutting, forming, assembling or separating machine or the machine tool is designed as testing, mounting, adjustment, surface treatment, packing or unpacking station, identification or cleaning station. The machine tool according to the invention is not determined in any way to the machining taking place in it. All machining possibilities mentioned before need the work piece to be positioned. Basically the positioning of the work piece should be carried out as time optimised and accurately as possible, which is—independently from the actual machining—solved by the invention. Therefore the invention can be used for any purpose of a machine tool. On the one hand it is possible that the machine tool actually machines the work piece, for example cuts it, forms it, assembles or separates it. Additionally, it is, however, also an advantage that the machine tool is designed as testing station in order to check, for example, corresponding machinings of a prior machine tool. It is an advantage here to provide suitable tests as early as possible so that not to recognise during the final check when a number of machinings already has been carried out that a mistake has occurred already in an early machining and the complete work piece is waste. It is also possible to design the machine tool as mounting station. It is, for example, possible to cut a thread into a previously carried out boring, and then to mount in the machine station another component into this thread. However, it is also possible to carry out, for example, a change of work piece carriers, that means for example to mount another work piece carrier.

However, it is also convenient to provide the mounting station for an accurate positioning, respectively alignment of the work piece. Furthermore it is possible that the machine tool is designed as surface treatment station. This serves, for example, for lacquering, electroplating, printing and so on. Also packing or unpacking stations are seen as machine tools which pack, for example, the work piece after machining or unpack it before machining.

Furthermore an installation for identification of work pieces may be provided as machine tool. In an identification station it is provided that, for example, labels or other identifications, if necessary even electronically readable identifications like bar code or transponder are fastened or attached to the work piece, respectively its work piece carrier or pallet in order to identify the respective work piece for the control. As a rule first a corresponding identification step has to be carried out (however not compulsory).

It is convenient here that as machine tool a cleaning station, respectively rinsing or washing station, is provided. Often work pieces are soiled during machining, for example by lubricants, which have to be washed up just at the end of the corresponding process line. It is not convenient, either, that corresponding oily emulsions remain on the work pieces if subsequently a surface treatment, like a lacquering or other coating, has to be carried out.

The machine tools mentioned before are designed to be automatically operating systems or manual work places in the sense of the invention.

### BRIEF DESCRIPTION OF THE DIFFERENT VIEWS OF THE DRAWINGS

The invention is schematically shown in the drawings. In the drawings:

FIG. 1 a top view of the production line according to the invention;

FIG. 2 a three dimensional view of an embodiment of the device according to the invention;

FIG. 3 a detail of the connection of the collecting module and the device according to the example of FIG. 2;

FIG. 4 a three dimensional view of another embodiment of the device according to the invention;

FIG. 5 a top view of a detail of an example of FIG. 4 and

FIGS. 6, 7, and 8 each a section of the modification of the device according to the invention of FIG. 4.

### DETAILED DESCRIPTION OF THE PREFERRED EMBODIMENT

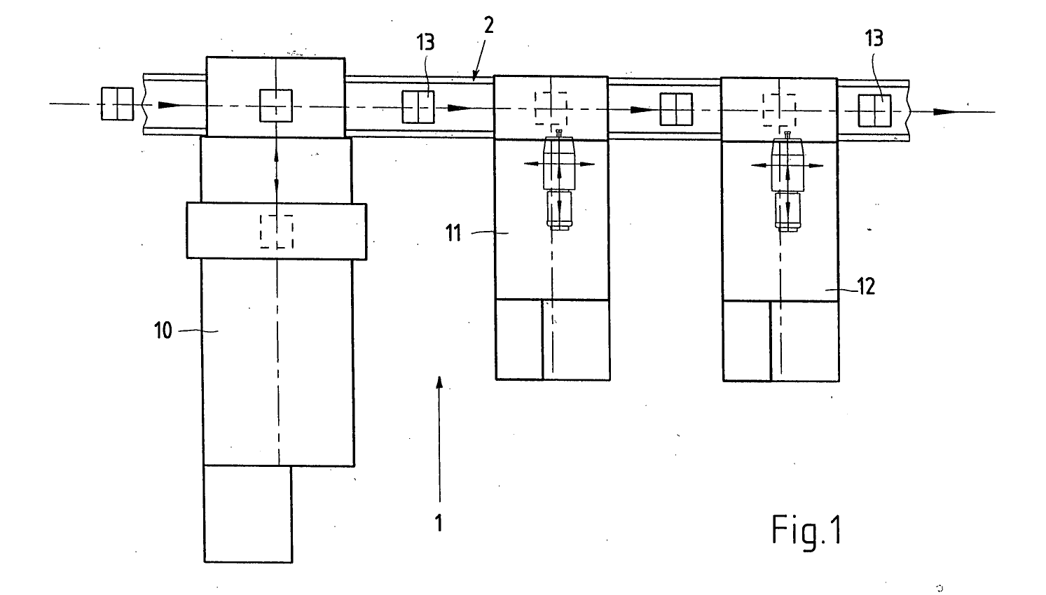

In FIG. 1 a schematic production line 1 according to the invention is shown.

The goods 13 are moved in a conveying line in the direction of the arrow. Several different machine tools 10, 11, 12 are provided. Between the machine tools 10, 11, 12 the device 2 for conducting rinsing/cooling fluid is arranged. It is positioned in FIG. 1 below the conveying line on which the goods 13 are conveyed.

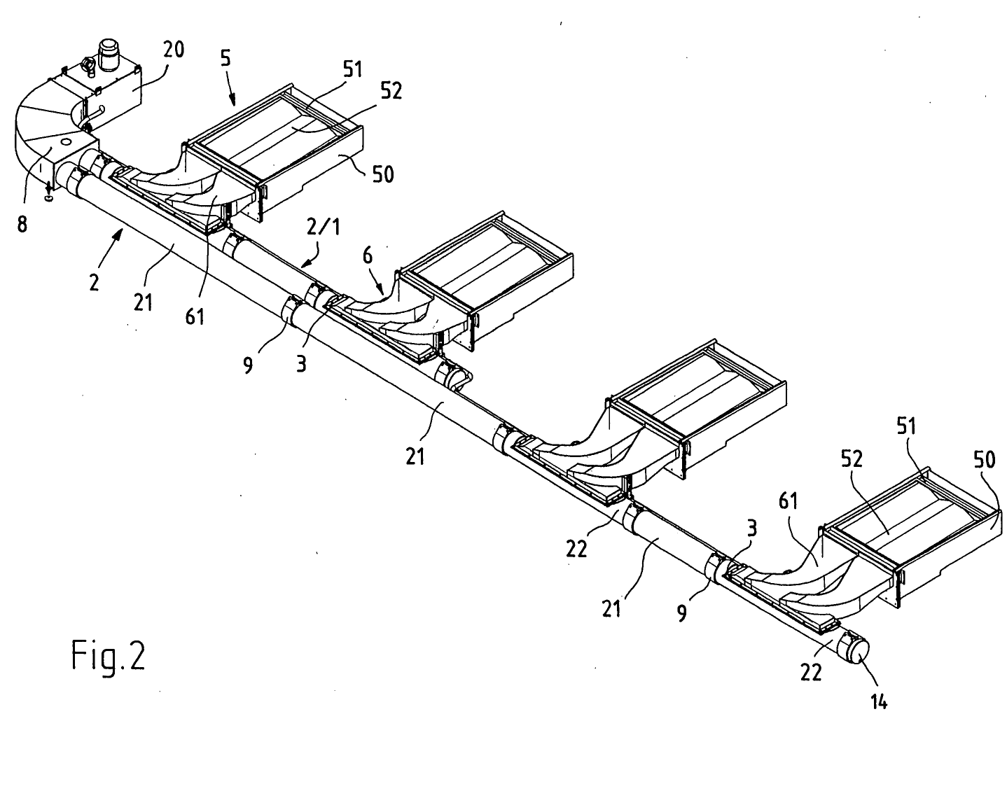

FIG. 2 shows in a three-dimensional view an embodiment of the device according to the invention. This is a very advantageous embodiment where the device 2 is designed tube-like. The device itself comprises several linked modules 20, 8, 21, and 22. At the beginning of the tube-like designed device 2 a connection module 22 is provided which is sealed by a lock 14. A tube-like linking module 21 is linked to this connection module 22. Then again a connection module 22 is connected, a linking module 21 as well as another linking module 21. At the end of the first part of the device 2 an enlargement module 8 is provided into which several devices 2, 2/1 can be integrated. The illustration is restricted only to two integrations. Of course it is, according to the invention, possible to integrate a number of devices 2 in such an enlargement module. The enlargement module 8 is here bent segment-like. The bending is, for example, necessary in order to guide the flow of rinsing or cooling fluid into a desired direction. At the end of the enlargement module 8 a final module 20 is linked which may comprise, for example, conveying or pumping devices, by means of which the arriving rinsing or cooling fluid can be guided or pumped into a central recycling installation, respectively a collecting container. Even here the invention is not restricted at all.

At each of the connection modules, respectively the connection 3 of the connection module 22, a collecting module 5 is provided. The collecting module 5 is connected with the device 2, respectively 2/1, via supplies 6 which are designed preferably as bent transition pieces 61. The device 2/1 is located in the second part (left hand part of the picture) parallel to the device 2 and is included also in the enlargement module 8. The collecting module 5 is formed here by a basic trough 50, in which a rinsing trough 51 is arranged. The rinsing trough 51 has a supply region 52 which is, as can be seen, shaped bent like W. This guarantees a proper letting off of the rinsing or cooling fluid and causes at the same time that the let off rinsing or cooling fluid cannot escape, respectively spill over, from the draining circle. A contamination of the surrounding of the supply region, respectively of the surrounding of the basic trough 50 is thus safely avoided as the basic trough 50 is arranged below a supply region of the machine tool which is not shown. Additionally at the edge of the basic trough 50 seals may be provided which provide a suitable impermeability. The embodiment of the basic trough as a two pieces shape with an integrated rinsing trough 51 secures a so-called double safety for avoiding soiling, respectively contamination, of the hall floor, respectively the set-up surface. The single modules 21 and 22 as well as the lock are linked by couplings, preferably in-line quick couplings. Between the couplings 9, of course, suitable seals are provided so that here also perfect impermeability is guaranteed. The advantage of the shown embodiment according to the invention is such that it is possible to connect a first group of machine tools to a first tube-like device 2. The drawing also shows that it is possible to connect each of two or more groups to its own device, preferably separated from other devices 2, 2/1, and that these devices are arranged at least in sections parallel, in particular running bunched. This embodiment is very advantageous and considerably lowers the expenses for manufacturing of such devices.

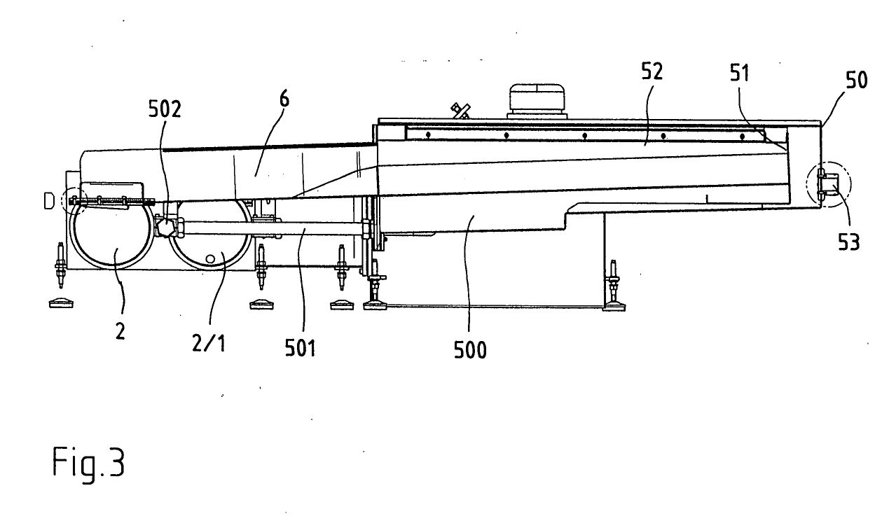

FIG. 3 shows a detail of the connection of collecting module 5 and device 2 according to an embodiment of FIG. 2. In the basic trough 50 a rinsing trough 51 is arranged. The supply region 52 is here (cannot be seen) designed W- or V-shaped bent, in particular the rinsing trough 51 in the basic trough 50 is designed slightly inclined in the direction to the device 2, respectively 2/1. Also the supply 6 has a small inclination which is, however, sufficient to pass the rinsing or cooling fluid securely into the device 2. Below the rinsing trough 51 the leakage trough 500 is located which is part of the basic trough 50. This leakage trough 500 also has a slight inclination in the direction to the device 2, respectively 2/1. The collected rinsing or cooling fluid is passed via a leakage duct 501 into a central leakage duct 502. This central leakage duct 502 may then be guided into an enlargement module 8 or into the final module 20 in order to let off the leakage there securely. As it can be seen in FIG. 3 the level of the leakage drain, respectively the arrangement of the leakage duct 501, is provided in such a way that it is located below the supply 6 for the rinsing or cooling liquid collected by the rinsing trough. An additional leakage duct is necessary also to make a secure sewage of the collected leakage easier. As it can be seen in FIG. 3 it is, if necessary, possible that the fluid level in the devices 2, respectively 2/1, is so high that the leakage could not drain, respectively it would be possible without a suitable reflux valve that rinsing or cooling fluid is pressed into the leakage trough 500. In order to avoid that securely a central leakage duct 502 is provided in order to let off the leakage securely, even if the liquid level is high in the devices 2, respectively 2/1. On the basic trough 50 a connection 53 is located for casing the production machine which is not shown. This connection 53 serves for letting off fluid which drips from the casing. By means of that a secure sewage of spilled, respectively dripping or splashing, rinsing or cooling liquid is secured altogether.

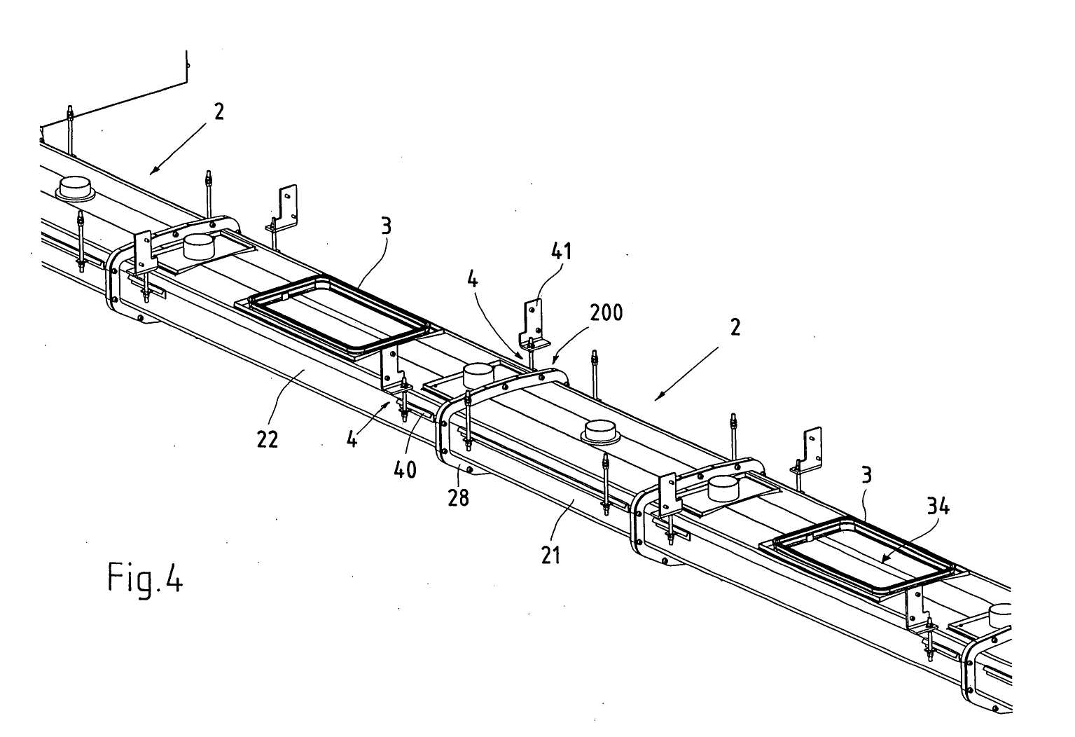

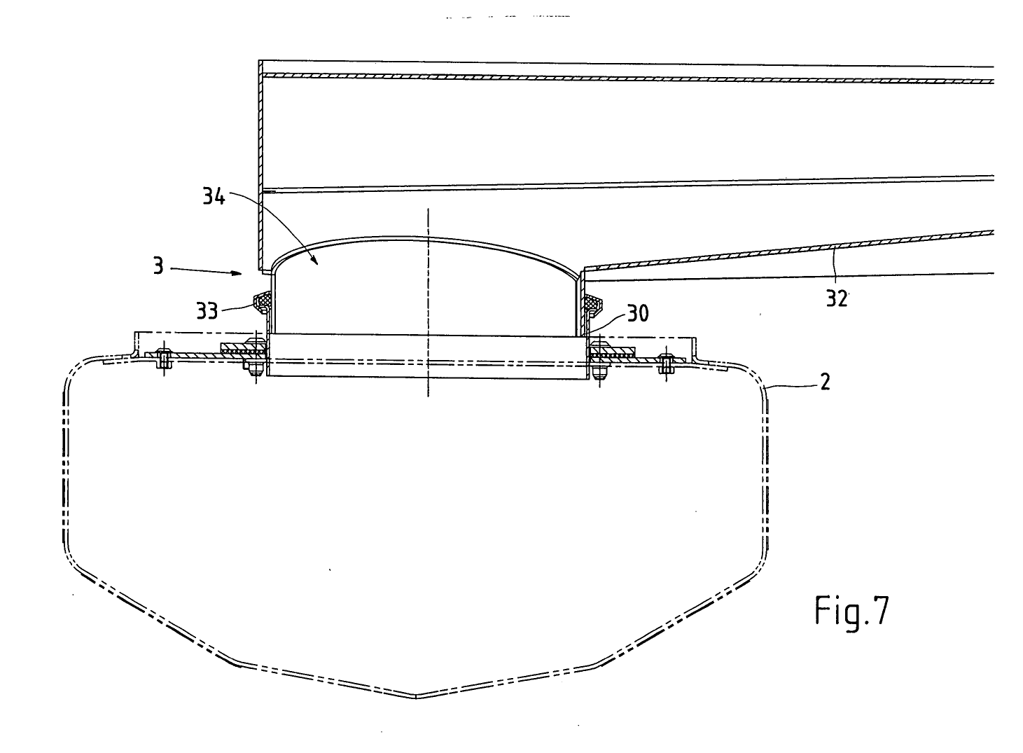

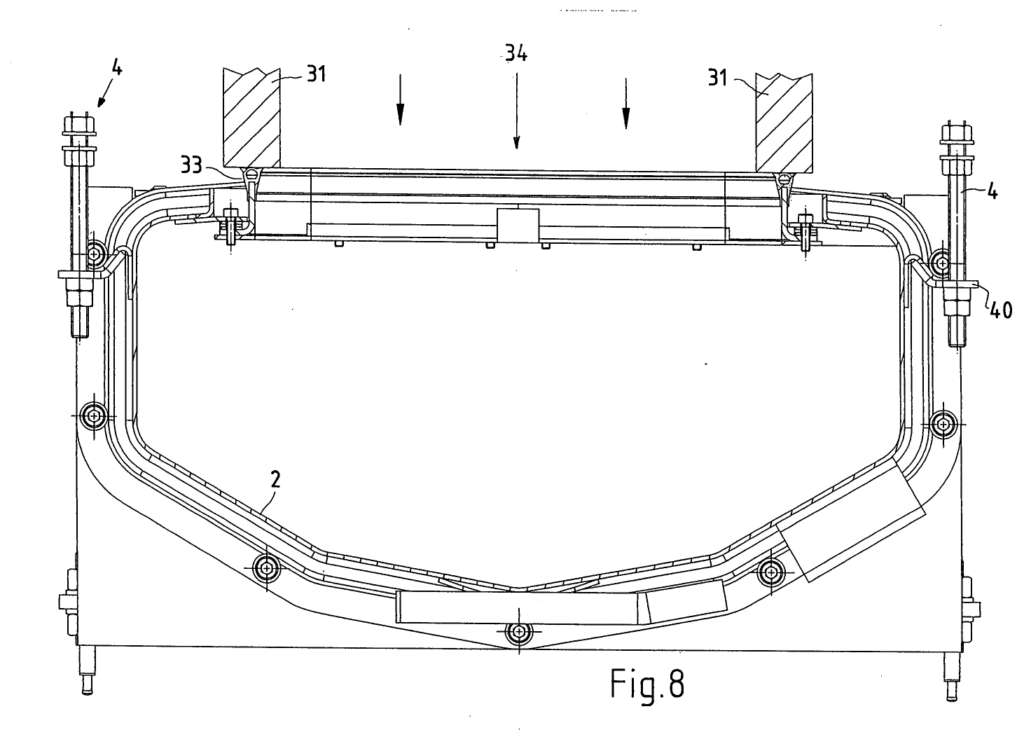

In FIG. 4 a modification of the device 2 according to the invention is shown clearer. Here the device 2 is assembled from a number of modules. Linking modules 21 are here arranged between connection modules 22. The connection modules 22 are here preferably in the region of the machine tools as they have a connection 3 which serves for connecting the chip collecting funnel 31 (see FIG. 8) or the rinsing channel 32 (see FIG. 7) through which the corresponding rinsing and cooling fluid, if necessary including also chips, rubbed-off parts or other soiling are removed from the machine tool. In the region of the connection 3 therefore extends the opening 34 through which the interior of the device 2 is accessible.

The modules each have on their ends a flange 28 and a mating flange 200, the flange 28 of the first module interacting with the mating flange 200 of the second module in order to join the modules. Between the flanges a seal 25 is provided.

The shown modification of the device according to the production line of the invention has support means 4 by means of which the device is held. The support means 4 here comprises a support slab 40, which is preferably arranged, for example welded, screwed on or riveted on the device 2 on the outer surface. The support mean 4 is designed, for example, as screw element, e.g. as a threaded rod or the like, and allows to be screwed into the corresponding thread of the support slab 40. For fastening the device 2 to the machine tool 10 or other elements in FIG. 1 a connecting slab 41 is shown. If necessary, also aid frames may be provided for receiving the connecting slab 41 which are independent from the machine frame or the machine tool 10, 11, 12.

The connecting slab 41 also has, for example, a thread which interacts with the thread of the support means. Twisting the support means causes a height adjustment, respectively an adjustment, which in particular serves also for a precise adjustment of the inclination of the device.

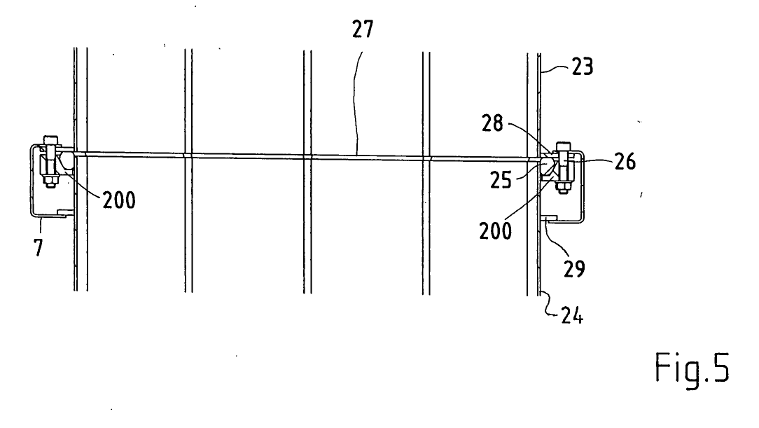

In FIG. 5 in a detail the connection region of two modules 23 and 24 arranged one beside the other of the embodiment of FIG. 4 is shown. The first module 23 has on its end a flange 28 projecting rectangular to the longitudinal extension of the module. As shown the flange 28 is arranged at the extreme end of the first module 23.

The second module 24 has a mating flange 200 which is designed bent and connected to the module slightly set back towards the end of the module. This results in a circulatory U- or V-shaped groove provided for receiving the seal 25.

The mating flange 200 receives the fixing devices 26 which connect the flange 28 with the mating flange 200. The seal 25 is here dimensioned in such a way that it projects in dismounted position from the recess into which it is inserted.

During mounting the modules 23, 24 for the time being a gap 27 remains which makes the assembling of the modules rectangular to the longitudinal extension of the modules possible and easy. This gap 27 is then closed by interaction of the fixing means 26, here screws and nuts, and the seal 25. This stable connection with the fixing means 26 presses the seal 25 into the recess in such a way that it sits securely on the walls of the recess and seals them. Furthermore the flange 28 is pressed with its complete circumference to the seal 25 and closes also possible gaps here. A sealed connection occurs between the two modules 23 and 24, the manipulation gap 27 being available for mounting.

The seal 25 is selected here in such a way that even mounting tolerances, for example different angle or height positions and so on, can be compensated without risking the impermeability of the device altogether.

Besides the use of fixing devices 26 for connecting the modules it is also possible to use known lock rings, as they are known, for example, for locking steel barrels. By a clever arrangement of the flanges and the design of the flanges here for locking the lock ring the flanges are also pressed towards each other and the seal for sealing the device compressed between them.

FIG. 5 also shows that a support arrangement 7 is linked to the fixing means 26 which serves, for example, for fastening a final module (20) or even another module. In order to avoid, for example, tilting of the module 24 the support arrangement 7 is used. The support arrangement 7 comprises here a number of essentially C-shaped profile sections, a first limb of this profile being supported by the flange 28, and the second limb of the C-profile sitting tight on a collar 29 of the second module 24. The collar 29 is here, with regard to the mating flange 200, even farther set back from the edge of the module. The flange 28, the mating flange 200, and/or the collar 29 are here attached on the respective modules 21, 22, 23, 24 for example by a welding joint.

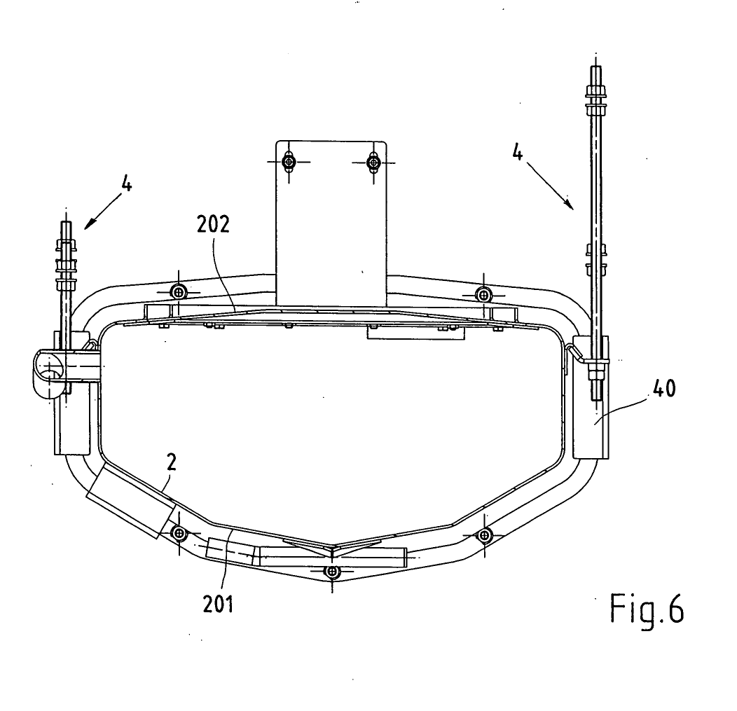

In FIG. 6 the preferably used cross-section of the modification of FIG. 4 of the device 2 is shown. This is a device 2, which is in its bottom part 201 shaped like a channel, and which is closed by a plate-like top part 202. The device 2 can here be in one piece or be created assembled from several components in a suitable construction and mounting. It may be convenient here that the bottom part 201 is manufactured separately from the top part 202 and then the two parts are, for example, screwed or welded together. The support means 4, the height and length of which can be set and adjusted, is connected to the support slab 40.

In FIG. 7 another example of the invention is shown. In this case the connection 3 is linked with a rinsing channel 32. At its rear end the rinsing channel has a pipe socket which intrudes into the flange 30 of the connection 3.

According to the invention it is provided that the connection 3 can be designed in any way, it may be designed here funnel-like, flange-like, rectangular, circular and so on.

At the end of flange 30 a bead is provided which produces a circumferential groove into which the connecting seal 33 can be put. For sealing this region there are several possibilities. It may be provided, for example, in a first modification that the seal 33 is guided in suitable stoppers and, if the device 2 is pressed against the rinsing channel 32, the seal 33 is compressed in such a way that it seals.

In another modification, as it is shown here, the seal 33 sits, because it is elastic, sealing at the inserted tube of the rinsing channel 32. This is in particular convenient as this arrangement allows, without any problems, even a height compensation of the device 2 with regard to the rinsing channel 32.

Besides the essentially circular design of the connection 3 according to FIG. 7, in FIG. 8 an essentially angled design is provided. In the embodiment shown here the connection 3 of the device 2 interacts with a funnel-shaped chip collector. The funnel is here designed for example rectangular. The sealing has here, compared to the design in FIG. 7, another shape. In FIG. 7 a seal is used which has a cylindrical cross-section and consists of solid material. The seal profile used in FIG. 8 is a bit more expensive as it has a U-shaped design by means of which the seal can be put on the upper edge of the connection 3. Then a region is connected which is equipped at its end with several sealing lips and elastic, which seals with the bottom region of the funnel 31. For that it is necessary that the device 2 is pressed from below against the funnel 31 which can be carried out without any problems by the support means 4.

According to the invention it is provided here that on the connection 3 a connecting seal 33 is provided, which is designed, if necessary, as continuous seal, for example as O-ring seal according to FIG. 7, or as sealing string or as sealing profile as in FIG. 8.

Although the invention has been described by exact examples which are illustrated in the most extensive detail, it is pointed that this serves only for illustration and that the invention is not necessarily limited to it because alternative embodiments and methods become clear for experts in view of the disclosure. Accordingly changes can be considered which can be made without departing from the contents of the described invention.

1. Production line comprising at least two machine tools standing on the floor where at least between the two machine tools a device for draining off rinsing or cooling fluid is provided, characterised in that the device (2) is essentially designed closed and sealed, in the region of the machine tool connections (3) are provided and the device (2) is arranged on the floor or above the level of the put-up surface of the machine tools.

2. Production line according to claim 1, characterised in that the device (2) is designed modularly.

3. Production line according to claim 1, characterised in that the device (2) is designed as an on-the-floor construction on the floor, which can, in particular, be set up below the machine tool.

4. Production line according to claim 1, characterised in that the device (2) is designed like a tube.

5. Production line according to claim 1, characterised in that a first group of several machine tools is connected with a first, in particular tube-like, device.

6. Production line according to claim 1, characterised in that two or more groups of machine tools are each connected with its own device (2), preferably separated from the other devices (2, 2/1), and that these devices are arranged at least in sections parallel, in particular running bunched.

7. Production line according to claim 1, characterised in that two or more groups of machine tools are each connected with its own device (2), preferably separated from the other devices (2, 2/1), and that these devices are arranged at least in sections parallel, in particular running bunched, and that an enlargement module (8) is provided for connecting two, respectively several, devices (2, 2/1).

8. Production line according to claim 1, characterised in that two or more groups of machine tools are connected each with its own device (2), preferably separated from the other devices (2, 2/1), and that these devices are arranged at least in sections parallel, in particular running bunched, and that an enlargement module (8) is provided for connecting two, respectively several, devices (2, 2/1), and that the enlargement module (8) is designed bent, in particular bent segment-like.

9. Production line according to claim 1, characterised in that two or more groups of machine tools are each connected with its own device (2), preferably separated from the other devices (2, 2/1), and that these devices are arranged at least in sections parallel, in particular running bunched, and that an enlargement module (8) is provided for connecting two, respectively several, devices (2, 2/1) and that a final module (20) is provided which contains all devices (2, 2/1) of the production line.

10. Production line according to claim 1, characterised in that the connections (3) in the region of the machine tools are connected by supplies (6) with the device (2).

11. Production line according to claim 1, characterized in that a collecting module (5) is provided for connecting the device (2) with the machine tool.

12. Production line according to claim 1, characterized in that the collecting module (5) for connecting the device (2) with the machine tool is designed as basic trough (50) where the rinsing or cooling fluid can be passed into.

13. Production line according to claim 1, characterized in that the collecting module (5) for connecting the device (2) with the machine tool is designed as basic trough (50) where the rinsing or cooling fluid can be passed into, and the basic trough (50) is provided in two pieces, in particular as an embodiment with a rinsing trough (51) in the basic trough (50).

14. Production line according to claim 1, characterized in that the collecting module (5) for connecting the device (2) with the machine tool is designed as basic trough (50) where the rinsing or cooling fluid can be passed into, and that the basic trough (50) is provided in two pieces, in particular as embodiment with a rinsing trough (51) in the basic trough (50), and that the rinsing trough (51) is designed at least in the region (52) where the rinsing, respectively cooling, fluid is passed into, respectively on the side facing the machine tool, is shaped W-like.

15. Production line according to claim 1, characterised in that the collecting module (5) for connecting the device (2) with the machine tool is designed as basic trough (50) where the rinsing or cooling fluid can be passed into, and that the basic trough (50) is provided in two pieces, in particular as embodiment with a rinsing trough (51) in the basic trough (50), and that the rinsing trough (51), respectively the basic trough (50), is designed inclined in the direction of the device (2), in particular slightly inclined.

16. Production line according to claim 1, characterised in that the collecting module (5) for connecting the device (2) with the machine tool is designed as basic trough (50) where the rinsing or cooling fluid can be passed into, and that the basic trough (50) is provided in two pieces, in particular as embodiment with a rinsing trough (51) in the basic trough (50), and that the W-shaped feeding region (52) of the rinsing trough (51) is formed by two V-channels.

17. Production line according to claim 1, characterised in that the supply (6) is provided as bent transition piece (61) for connecting with the device (2).

18. Production line according to claim 1, characterized in that the collecting module (5) for connecting the device (2) with the machine tool is designed as basic trough (50) where the rinsing or cooling fluid can be passed into, and that the basic trough (50) is provided as housing for the rinsing trough (51).

19. Production line according to claim 1, characterized in that the collecting module (5) for connecting the device (2) with the machine tool is designed as basic trough (50) where the rinsing or cooling fluid can be passed into, and that the basic trough (50) is additionally at least partially designed as leakage trough (500) in such a way that rinsing, respectively cooling, fluid spilling over from the rinsing trough (51) is collected.

20. Production line according to claim 1, characterised in that the collecting module (5) for connecting the device (2) with the machine tool is designed as basic trough (50) where the rinsing or cooling fluid can be passed into, and that the basic trough (50) is designed additionally at least partially as leakage trough (500) in such a way that rinsing, respectively cooling, fluid spilling over from the rinsing trough (51) is collected and a leakage duct (501) is provided through which the leakage can be let off from the leakage trough (500).

21. Production line according to claim 1, characterised in that the collecting module (5) for connecting the device (2) with the machine tool is designed as basic trough (50) where the rinsing or cooling fluid can be passed into, and that the basic trough (50) is additionally at least partially designed as leakage trough (500) in such a way that rinsing, respectively cooling, fluid spilling over from the rinsing trough (51) is collected, and a leakage duct (501) is provided through which the leakage can be let off from the leakage trough (500) and the leakage duct (501) is arranged on a level below the rinsing trough (51), respectively the supply (6).

22. Production line according to claim 1, characterised in that the collecting module (5) for connecting the device (2) with the machine tool is designed as basic trough (50) where the rinsing or cooling fluid can be passed into, and that the basic trough (50) is additionally at least partially designed as leakage trough (500) in such a way that rinsing, respectively cooling, fluid spilling over from rinsing trough (51) is collected and a leakage duct (501) is provided through which the leakage can be removed from the leakage trough (500), and a central leakage collective duct (502) is arranged parallel to the device (2).

23. Production line according to claim 1, characterised in that the collecting module (5) for connecting the device (2) with the machine tool is designed as basic trough (50) where the rinsing or cooling fluid can be passed into, and that on the basic trough (50) a connection (53) is provided to the casing of the production machine in order to remove liquid dripping on the casing.

24. Production line according to claim 1, characterised in that the device (2) is designed modularly and essentially closed, profile-like linking modules (21) are provided.

25. Production line according to claim 1, characterized in that the device (2) is designed modularly and connection modules (22) with at least one connection (3) are provided.

26. Production line according to claim 1, characterized in that the device (2) has a cross-section of a one-piece component.

27. Production line according to claim 1, characterised in that the device is designed as a weldment comprising at least a bottom part (201) and a top part (202).

28. Production line according to claim 1, characterized in that the device (2) comprises a bottom part (201) and a top part (202) which can be put on the bottom part (201) and which can be connected tight with it, for example by means of screws.

29. Production line according to claim 1, characterized in that the device (2) has a cross section which is circular, oval, box-shaped or channel-like.

30. Production line according to claim 1, characterised in that the device (2) is designed modularly and the modules can be connected by means of fixing devices (26) like a lock ring, a screw connection or the like.

31. Production line according to claim 1, characterized in that the device (2) is designed modularly and the modules can be connected by means of fixing devices (26), like a lock ring, a screw connection or the like, and that on the fixing device (26) a support arrangement (7) is provided for a module which has to be attached, in particular a final module (20).

32. Production line according to claim 1, characterised in that the device (2) is designed modularly and the module (21, 22, 23, 24) has at least on one of its longitudinal ends a sealing (25) and during mounting at least one gap (27) remains which is sealed by inter-action of the fixing devices (26) and the sealing (25) in the mounted state.

33. Production line according to claim 1, characterised in that the connection (3) is designed either like a funnel or a flange, square or circular.

34. Production line according to claim 1, characterized in that on the connection (3) a connecting seal (33) is provided, in particular as continuous seal or seal string.

35. Production line according to claim 1, characterised in that either a chip collecting funnel (31) or a rinsing channel (32) of the machine tool (10) can be connected to the connection (3).

36. Production line according to claim 1, characterized in that a support means (4) of the device (2) is provided on the device.

37. Production line according to claim 1, characterized in that a support means (4) the length, respectively height, of which can be adjusted is provided on the device (2).

38. Production line according to claim 1, characterized in that a support on the machine tool (10), respectively on the machine frame, serves as support means (4) of the device (2).

39. Production line according to claim 1, characterised in that by means of the support means (4) the device (2) is suspended or supported on the machine tool (10), respectively the machine frame.

40. Production line according to claim 1, characterised in that set-up feet set up on the floor serve as support means (4) for the device (2).

41. Production line according to claim 1, characterised in that the machine tool is designed as cutting, forming, assembling or separating machine, or the machine tool is designed as testing station, mounting station, adjustment station, surface treatment station, packing or unpacking station, identification station or as cleaning station.
